(19) United States
(12) Patent Application Publication
(10) Pub. No.: US 2020/0173502 A1
(43) Pub. Date: Jun. 4, 2020

(54) Coupling Assembly Having Substantially No Backlash Between Forward and Reverse Locking Elements of the Assembly

(71) Applicant: Means Industries, Inc., Saginaw, MI (US)

(72) Inventor: Scott D. Bostian, Kingston, MI (US)

(73) Assignee: Means Industries, Inc., Saginaw, MI (US)

(21) Appl. No.: 16/684,762

(22) Filed: Nov. 15, 2019

Related U.S. Application Data
(60) Provisional application No. 62/774,356, filed on Dec. 3, 2018.

(51) Int. Cl. F16D 41/16

(52) U.S. Cl. CPC F16D 41/16

(57) ABSTRACT

A controllable coupling assembly having substantially no backlash is provided. The assembly includes a set of reverse locking formations each of which includes a load bearing surface having a sloped geometry and being adapted to lock a reverse locking element in place along the load bearing surface based on a mechanical tolerance between load bearing surfaces of forward and reverse locking elements through a wedging effect to prevent relative rotation between first and second coupling members of the assembly in a reverse direction about a rotational axis, to absorb at least a portion of the tolerance and to substantially eliminate any backlash between the locking elements.

### CROSS-REFERENCE TO RELATED APPLICATIONS

This application claims the benefit of U.S. provisional application Ser. No. 62/774,356, filed Dec. 3, 2018, the disclosure of which is hereby incorporated in its entirety by reference herein.

### TECHNICAL FIELD

At least one embodiment of this invention generally relates to the field of coupling assemblies having an overrun mode and forward and reverse locking elements such as struts for use therein.

### OVERVIEW

As described in U.S. Pat. No. 8,844,693 (i.e., see FIG. 6 herein which corresponds to FIG. 3 of the patent), overrunning coupling assemblies may be used for transferring torque from a driving member to a driven member in a variety of structural environments. This permits the transfer of torque from a driving member to a driven member while permitting freewheeling motion of the driving member relative to the driven member when torque is interrupted. Such couplings often comprise an outer race concentrically disposed with respect to an inner race, the outer race having cammed surfaces that define a pocket in which coupling rollers are assembled.

The driving member is connected to one race, and the driven member is connected to the other race. During torque transfer from the driving member to the driven member, the rollers become locked with a camming action against the cam surfaces, thereby establishing a positive driving connection between the driving member and the driven member. When the torque is interrupted, the driven member may freewheel relative to the driving member as the rollers become unlocked from their respective cam surfaces.

Another common overrunning coupling includes overrunning coupling sprags disposed between the inner cylindrical surface of an outer race and the outer cylindrical surface of an inner race so that the sprags lock the races together as torque is delivered to the driven member. The sprags become unlocked with respect to the inner and outer race surfaces when torque is interrupted.

A pocket plate may be provided with angularly disposed recesses or pockets about the axis of a one-way clutch. The pockets are formed in the planar surface of the pocket plate. Each pocket receives a torque transmitting strut, one end or tail of which engages an anchor point in a pocket of the pocket plate. An opposite edge of the strut, which may hereafter be referred to as an active edge or nose, is moveable from a position within the pocket to a position in which the active edge extends outwardly from the planar surface of the pocket plate. The struts may be biased away from the pocket plate by individual springs.

A notch plate may be formed with a plurality of recesses or notches located approximately on the radius of the pockets of the pocket plate. The notches are formed in the planar surface of the notch plate.

Another example of an overrunning planar clutch is disclosed in U.S. Pat. No. 5,597,057.

Other U.S. patents related to the present invention include: U.S. Pat. Nos. 5,070,978; 5,449,057; 5,806,643; 5,871,071; 5,918,715; 5,964,331; 5,927,455; 5,979,627; 6,065,576; 6,116,394; 6,125,980; 6,129,190; 6,186,299; 6,193,038; 6,244,965; 6,386,349; 6,481,551; 6,505,721; 6,571,926; 6,854,577; 7,258,214; 7,275,628; 7,344,010; and 7,484,605.

As disclosed in FIG. 1 (i.e. FIG. 10 of U.S. Pat. No. 6,186,299), a strut pocket is sufficiently enlarged in a direction forward of the front edge of the strut to allow sliding movement of the strut from the position shown in phantom to the overrun position shown in solid lines wherein the forward corner of the strut engages the outer circumferential rail of the notch plate during overrunning to prevent the struts from slapping against the notch recesses during overrunning. Each strut pocket provides sufficient clearance forward of the respective opposite edge of the strut to allow forward sliding movement of the respective strut during overrunning to cause the engagement of the respective spring and strut to occur nearer the ear axis, thereby reducing the length of a moment arm about which the spring acts upon the strut.

Yet still other related U.S. patents include: U.S. Pat. Nos. 4,200,002; 5,954,174; and 7,025,188.

More recent related patent documents include U.S. Pat. Nos. 7,100,756; 7,223,198; 7,383,930; 7,448,481; 7,451,862; 7,455,156; 7,455,157; 7,450,545; 7,614,486; 7,661,518; 7,743,678; 7,942,781; 7,980,372; 7,992,695; 8,042,699; 8,042,670; 8,051,959; 8,056,690; 8,079,453; 8,083,042; 8,091,696; 8,286,772; 8,602,187; 8,491,439; 8,646,587; 8,720,659; 8,844,693; 8,881,516; 8,986,157; 9,121,454; 9,186,977; 9,188,170; 9,188,172; and 9,188,174. Also included are published U.S. patent application Nos. 2008/0110715; 2011/0269587; 2011/0183806; 2011/0214962; 2011/0297500; 2008/0169165; 2009/0159391; 2010/0288592; 2014/0116832; 2014/0190785; and 2016/0230819.

As disclosed in FIGS. 2 and 3 (i.e. FIGS. 8 and 10, respectively, of U.S. Pat. No. 9,121,454), a locking member for controllably transmitting torque between first and second coupling members of a coupling assembly is shown. The locking member includes projecting inner and outer pivots which extend laterally from a main body portion for enabling pivotal motion of the locking member about a pivot axis which intersects the pivots. The pivots are sized, shaped and located with respect to the main body portion to allow frictional engagement of an end surface of the outer pivot with an outer wall of a pocket to occur near the pivot axis during rotation of the first coupling member and the locking member above a predetermined RPM thereby reducing overall moment on the locking member about the pivot axis that has to be overcome to move the locking member between the engaged and disengaged positions.

FIGS. 4, 5a and 5b (i.e. FIGS. 4a and 2, respectively, of U.S. Publication No. 2016/0160942) discloses a selectable one-way clutch (i.e. SOWC) configured to prevent unintentional engagement. A pawl comprises a strut that is pushed up toward a notch through an aperture of a selector plate, a stopper plate protruding laterally from a rear end side of the strut, and a first inclined face formed on the stopper plate to incline downwardly from the rear end side toward the leading end side of the strut. A side plate is formed along each long side of the aperture to protrude toward the pocket plate, and the second inclined face is formed on the side plate to be brought into contact to the first inclined face.

Metal injection molding (MIM) is a metalworking process where finely-powdered metal is mixed with a measured amount of binder material to comprise a “feedstock” capable of being handled by plastic processing equipment through a process known as injection mold forming. The molding process allows complex parts to be shaped in a single operation and in high volume. End products are commonly component items used in various industries and applications. The nature of MIM feedstock flow is defined by a physics called rheology. Current equipment capability requires processing to stay limited to products that can be molded using typical volumes of 100 grams or less per “shot” into the mold. Rheology does allow this “shot” to be distributed into multiple cavities, thus becoming cost-effective for small, intricate, high-volume products which would otherwise be quite expensive to produce by alternate or classic methods. The variety of metals capable of implementation within MIM feedstock are referred to as powder metallurgy, and these contain the same alloying constituents found in industry standards for common and exotic metal applications. Subsequent condition operations are performed on the molded shape, where the binder material is removed and the metal particles are coalesced into the desired states for the metal alloy.

For purposes of this application, the term “coupling” should be interpreted to include clutches or brakes wherein one of the plates is drivably connected to a torque delivery element of a transmission and the other plate is drivably connected to another torque delivery element or is anchored and held stationary with respect to a transmission housing. The terms “coupling”, “clutch” and “brake” may be used interchangeably.

A “moment of force” (often just “moment”) is the tendency of a force to twist or rotate an object. A moment is valued mathematically as the product of the force and a moment arm. The moment arm is the perpendicular distance from the point or axis of rotation to the line of action of the force. The moment may be thought of as a measure of the tendency of the force to cause rotation about an imaginary axis through a point.

In other words, a “moment of force” is the turning effect of a force about a given point or axis measured by the product of the force and the perpendicular distance of the point from the line of action of the force. Generally, clockwise moments are called “positive” and counterclockwise moments are called “negative” moments. If an object is balanced then the sum of the clockwise moments about a pivot is equal to the sum of the counterclockwise moments about the same pivot or axis.

As disclosed in U.S. published patent application 2018/0172088 selectable one-way clutches typically require a certain amount of backlash to switch modes. However, this backlash may cause driveline jolts that can be felt by a driver or operator.

Accordingly, there remains a need in the art for a selectable multi-mode clutch assembly that can provide torque translation in either rotational direction while also minimizing or eliminating the backlash inherent in prior art designs.

The following recent U.S. patent documents discuss various ways of dealing with backlash in one-way clutches: 2018/0087586; 2018/0066716; 9,482,297; and 10,029,563.

U.S. published patent application 2018/087585 discloses a coupling assembly having an overrun mode and an appendaged locking member for use therein. A control element or member engages the appendage to create a moment of the locking member about a pivot axis to urge the locking element or member from a coupling position towards an uncoupling position. The moment decreases the amount of force needed by the control element to move the locking member out of the coupling position wherein a higher torque-locked assembly can be disengaged with lower force.

Tolerance zones exist in all component parts that make up a vehicle. These tolerance zones indicate how much a specific location is prone to deviate from an ideal position. The tolerance zone for an assembly of parts is affected by how the individual parts of the assembly collectively deviate from their ideal part definitions.

Despite the above, there is still a need to remove or eliminate backlash between forward and reverse locking members or elements in a selectable one-way clutch (SOWC).

### SUMMARY OF EXAMPLE EMBODIMENTS

An object of at least one embodiment of the invention is to provide a controllable coupling assembly having substantially no backlash between forward and reverse locking members or elements while absorbing mechanical tolerance produced during fabrication and assembly of the coupling assembly.

In carrying out the above object and other objects of at least one embodiment of the present invention, a controllable coupling assembly having substantially no backlash is provided. The assembly includes a forward locking element including a nose end with a load bearing surface and a reverse locking element including a nose end with a load bearing surface. A distance between the load bearing surfaces has a mechanical tolerance when the locking elements are both in their locked positions. The assembly also includes first and second coupling members supported for relative rotation about a common rotational axis. The coupling members include a first coupling face having a forward pocket to receive the forward locking element and a second coupling face having a set of forward locking formations. Each of the set of forward locking formations is adapted for abutting engagement with the load bearing surface of the forward locking element in its locked position to prevent the relative rotation in a forward direction about the axis. The second coupling face also has a set of reverse locking formations. Each of the set of reverse locking formations includes a load bearing surface having a sloped geometry and being adapted to lock the reverse locking element in place along the load bearing surface of its reverse locking formation based on the mechanical tolerance through a wedging effect to prevent relative rotation in a reverse direction about the axis, to absorb at least a portion of the tolerance and to substantially eliminate any backlash between the locking elements in their locked positions.

The first coupling face may have a reverse pocket to receive the reverse locking element.

The assembly may include a plurality of reverse locking elements wherein the first coupling face may have a plurality of reverse pockets to receive the reverse locking elements.

The first coupling face may be oriented to face axially in a first direction along the axis, wherein the second coupling face is oriented to face axially in a second direction opposite the first direction along the axis.

The forward and reverse locking elements may be locking struts.

The forward and reverse locking formations may include notches.

The reverse locking formations may be staggered to absorb at least a portion of the tolerance.

The assembly may further include a control member mounted for controlled, shifting movement between the first and second coupling faces relative to the reverse pockets and operable for controlling position of the reverse locking elements. The control member may allow at least one of the reverse locking elements to engage at least one of the reverse locking formations in a first position of the control member wherein the control member may maintain the reverse locking elements in their pockets in a second position of the control member.

The control member may comprise a slide plate controllably rotatable about the rotational axis between the first and second positions.

The reverse locking element may have a control member-engaging appendage at its nose end.

Further in carrying out the above object and other objects of at least one embodiment of the present invention, a controllable clutch assembly having substantially no backlash is provided. The assembly includes a forward locking element including a nose end with a load bearing surface. The assembly also includes a reverse locking element including a nose end with a load bearing surface. A distance between the load bearing surfaces has a mechanical tolerance when the locking elements are both in their locked positions. The assembly further includes first and second clutch members supported for relative rotation about a common rotational axis. The clutch members include a first clutch face having a forward pocket to receive the forward locking element and a second clutch face having a set of forward locking formations. Each of the set of forward locking formations is adapted for abutting engagement with the load bearing surface of the forward locking element in its locked position to prevent the relative rotation in a forward direction about the axis. The second clutch face also includes a set of reverse locking formations. Each of the set of reverse locking formations includes a load bearing surface having a sloped geometry and adapted to lock the reverse locking element in place along the load bearing surface of its reverse locking formation based on the mechanical tolerance through a wedging effect to prevent relative rotation in a reverse direction about the axis, to absorb at least a portion of the tolerance and to substantially eliminate any backlash between the locking elements in their locked positions.

The first clutch face may have a reverse pocket to receive the reverse locking element.

The assembly may include a plurality of reverse locking elements wherein the first clutch face may have a plurality of reverse pockets to receive the reverse locking elements.

The first clutch face may be oriented to face axially in a first direction along the axis, wherein the second clutch face may be oriented to face axially in a second direction opposite the first direction along the axis.

The forward and reverse locking elements may be locking struts.

The forward and reverse locking formations may include notches.

The reverse locking formations may be staggered to absorb at least a portion of the tolerance.

The assembly may further include a control member mounted for controlled, shifting movement between the first and second clutch faces relative to the reverse pockets and operable for controlling position of the reverse locking elements. The control member may allow at least one of the reverse locking elements to engage at least one of the reverse locking formations in a first position of the control member wherein the control member may maintain the reverse locking elements in their pockets in a second position of the control member.

The control member may comprise a slide plate controllably rotatable about the rotational axis between the first and second positions.

The reverse locking element may have a control member-engaging appendage at its nose end.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### BRIEF DESCRIPTION OF THE DRAWINGS

FIG. 1 is a top plan view, partially broken away, of a prior art pocket plate and a strut slideable within a pocket of the plate;

FIG. 2 is a side view, partially broken away and in cross section, of a prior art coupling assembly with a locking member or strut shown in its uncoupling position;

FIG. 3 is a view similar to the view of FIG. 3, with the strut in its locking position;

FIG. 4 is a side view, partially broken away and in cross section, of a prior art coupling assembly with its strut in its uncoupling position;

FIG. 5A is a bottom perspective view, partially broken away, of a selector plate of the assembly of FIG. 4;

FIG. 5B is a top perspective view of the strut of the assembly of FIG. 4;

FIG. 6 is a side view, partially broken away, of a prior art coupling assembly with a locking member of the assembly extending between driving and driven numbers of the assembly;

FIG. 7 is an exploded perspective view of a controllable clutch or coupling assembly constructed in accordance with one embodiment of the present invention;

FIG. 8 is a view similar to the view of FIG. 7 but taken from a different direction to illustrate the bottom surfaces of the assembly;

FIG. 9 is a side elevational view, partially broken away and in cross section, of the assembly of FIGS. 7 and 8 with forward and reverse locking members in their extended locking positions;

FIG. 10 is a top plan view, partially broken away, of a pocket plate of the assembly of FIGS. 7 and 8 with forward and reverse locking members in phantom;

FIG. 11 is an enlarged view taken within the circle 11 in FIG. 10, but with a first reverse locking member and its tolerance zone shown in solid lines;

FIG. 12 is an enlarged view taken within the circle 12 in FIG. 10 with a second reverse locking member and its tolerance zone shown in solid lines; and

FIG. 13 is a side elevational view of a forward locking member in its various positions shown by phantom lines.

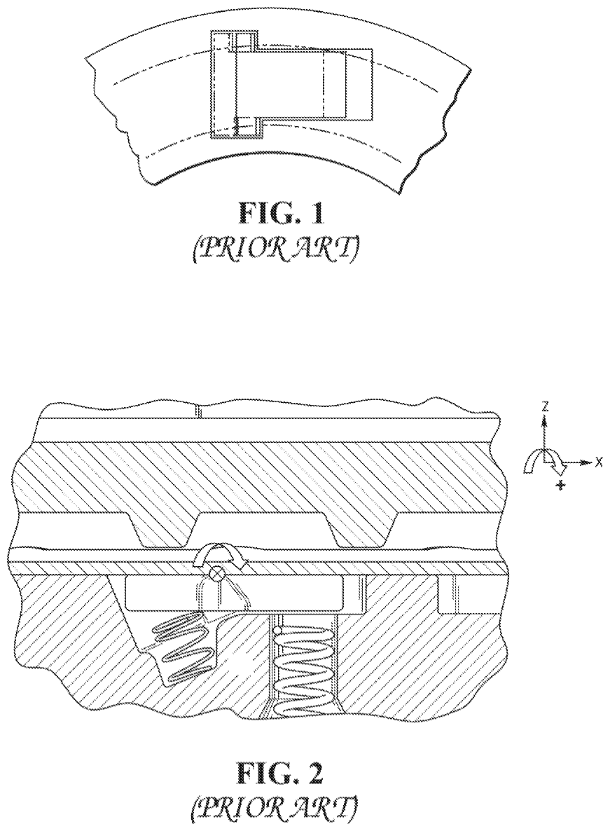

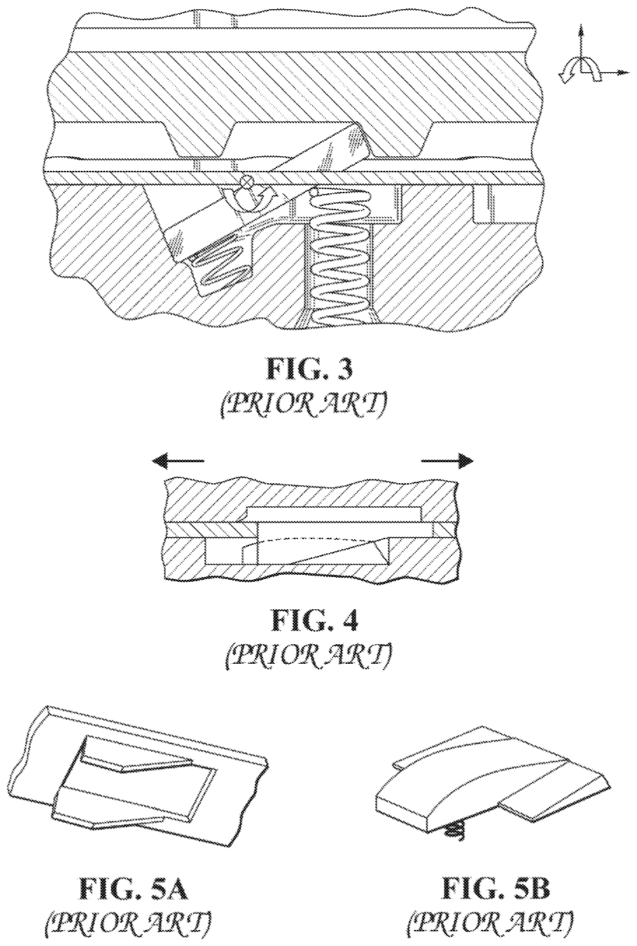

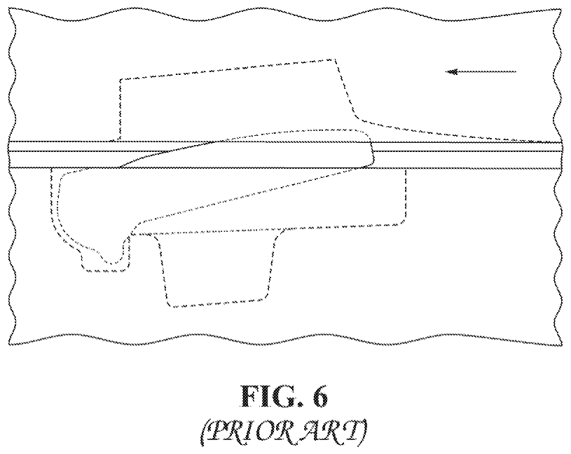

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

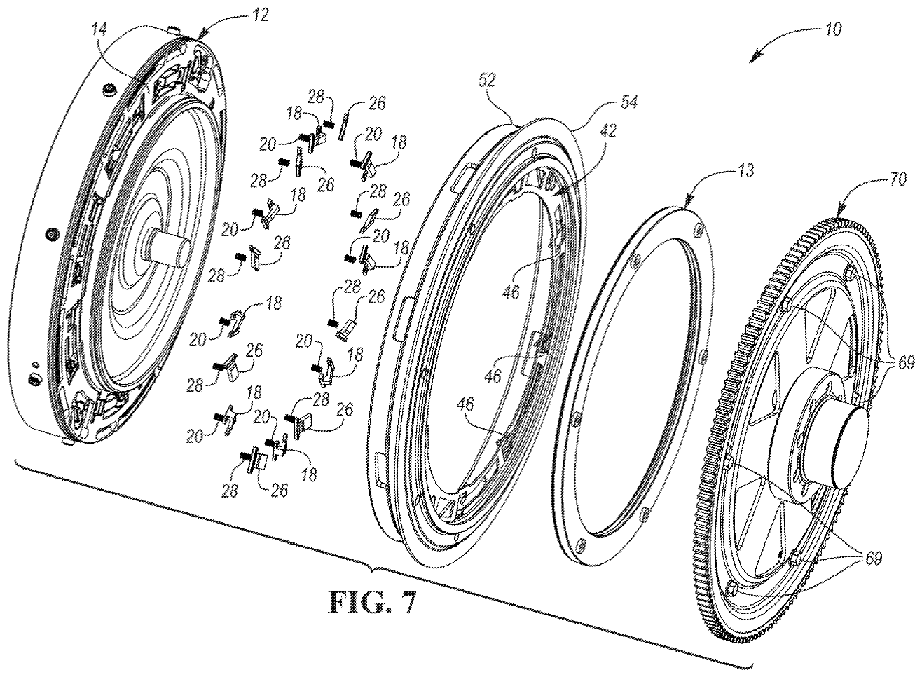

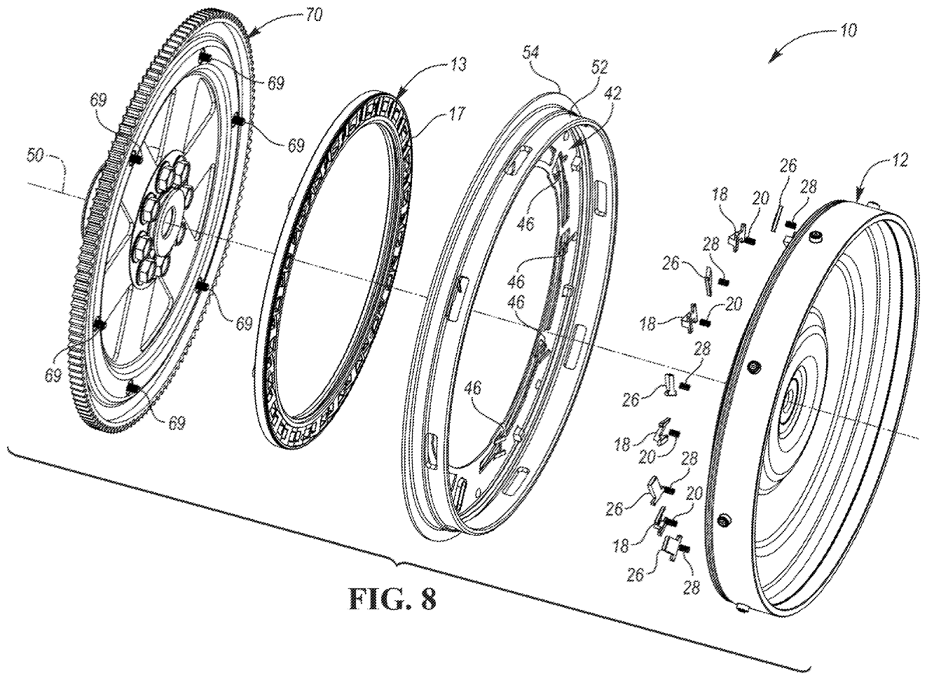

Referring now to the drawing figures, FIGS. 7 and 8 are exploded perspective views (taken from different directions to illustrate different surfaces of the components of the assembly) of a controllable one-way clutch or coupling assembly, generally indicated at 10, constructed in accordance with at least one embodiment of the present invention.

As best shown in FIGS. 7-9, the assembly 10 includes an annular pocket plate or coupling member, generally indicated at 12. An inner radially extending surface or coupling face 14 of the plate 12 is formed with spaced reverse pockets 16 in which appendaged reverse struts, generally indicated at 18, are pivotally biased outwardly by coil springs 20 disposed within recesses 22 formed in the reverse pockets 16. Preferably, eight reverse struts 18 are provided. However, it is to be understood that a greater or lesser number of reverse struts 18 may be provided.

In a similar fashion, the coupling face 14 of the plate 12 is formed with spaced forward pockets 24 in which forward struts, generally indicated at 26, are pivotally biased outwardly by coil springs 28 disposed within recesses 30 formed in the forward pockets 24. Preferably, eight forward struts 26 are provided and alternate with the eight reverse struts 18. However, a greater or lesser number of forward struts 26 may be provided.

Each of the “eared” forward struts or pawls 26 include a planar substantially rectangular portion with a nose end having a load bearing surface and a pair of ears, as generally shown in U.S. Pat. No. 6,065,576.

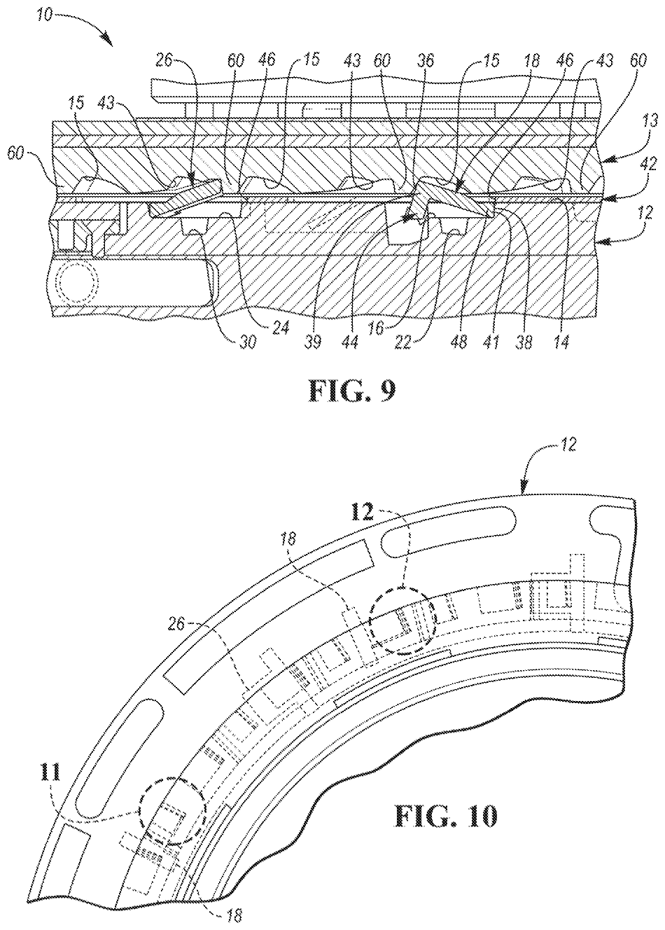

As disclosed in FIG. 9 herein and FIGS. 10A, 10B and 10C of published patent application 2018/0087585, each of the reverse pawls or struts 18 includes a first end, load bearing surface or face 36 at a nose end 39 of the strut 18. Each strut 18 further includes a second end surface or face 38 at a tail end 41 of the strut 18 diametrically opposite the first end surface 36. The tail end 41 engages a shoulder in the pocket plate 12. The strut 18 further includes upper and lower faces of a main body portion of the strut 18. After manufacture and assembly of the components of the assembly 10 a distance between the load bearing surfaces of the forward and reverse locking elements 26 and 18, respectively, have a mechanical tolerance when the locking elements 26 and 18 are both in their locked positions as shown in FIG. 9.

The assembly 10 also preferably includes a control member or selector slide plate, generally indicated at 42, having a plurality of spaced apertures 46 extending completely therethrough to allow the reverse struts 18 to pivot in their pockets 16 (and the forward struts 26 to pivot in their pockets 24) and extend through the apertures 46 to engage spaced reverse locking formations or ramped reverse notches 15 (and forward notches 43) formed in a radially extending surface or coupling face 17 of a notch plate or coupling member, generally indicated at 13, when the plate 42 is properly angularly positioned about a common central rotational axis 50 by a shift fork or control element (not shown) which extends through a notch or slot (not shown) formed through an outer circumferential end wall 52 of a plate 54 which supports the plate 42. The fork is secured or coupled to the control plate 42 so that movement of the fork in its slot between different angular positions causes the plate 42 to slide or shift between its control positions to alternately cover or uncover the struts 18 and the struts 26 (i.e., to engage or disengage the reverse and forward struts 18 and 26, respectively).

Referring collectively to FIGS. 7, 8 and 9, as previously mentioned, the assembly 10 also includes the second outer coupling member or notch plate 13, which has the plurality of locking formations or cams 60 formed in the radially extending surface or coupling face 17 thereof by which the forward struts 26 lock the plate 12 to the notch plate 13 in one direction about the axis 50 but allow the free-wheeling in the opposite direction about the axis 50. In like fashion, the formations 60 allow the reverse struts 18 to lock the plate 12 to the notch plate 13 in the opposite direction about the axis 50. The notch plate 13 is typically bolted via bolts 69 to a gear plate 70 for rotation therewith.

Each of the reverse struts 18 also includes a control element-engaging appendage, generally indicated at 44, which extends downwardly from the lower face of its main body portion towards its nose 39 and away from its tail 41. As described in published U.S. application 2018/0087585, the control element 42 exerts a force on the appendage 44 when the control element 42 is rotated and the strut 18 extends through the aperture 46 in the plate 42 to create a moment of the locking member 18 about a pivot axis which intersects pivots 48 of the locking member or strut 18. This movement urges the locking member or strut 18 towards an uncoupling position characterized by non-abutting engagement of the nose 39 with the first member or notch plate 13 of the assembly 10 upon rotation (i.e. in a first direction) of the plate 13 relative to the pocket plate 12 to prevent abutting engagement of the strut 18 with a shoulder of the plate 13 in the overrun mode of the assembly 10.

The appendage 44 includes a pair of oppositely projecting ears which extend laterally and have control element-engaging faces on their opposite sides. The reverse pawls or struts 18 each have the pair of oppositely projecting pivots 48 which extend laterally from their tails 41 and define the pivot axis of the struts 18 as described in published application 2018/0087585.

The forward and reverse struts 26 and 18, respectively, may be formed from a length of thin, cold-formed stock material, such as a cold-drawn or cold-rolled wire or spheroidized and annealed SAE 1065 steel. Each strut 18 or 26 may be tumbled to achieve a suitable edge corner break, such as a maximum of 0.015 inches; hardened at 1550° F.; oil quenched; and tempered at 350° F. to a minimum hardness of 53 Rockwell-C. Alternatively, the struts 18 and 26 may be formed via metal injection molding.

When the forward struts 26 are carrying torque in a rotational manner and the reverse struts 18 are commanded “on”, the reverse struts 18 engage into the notch 15 which has a “sloped geometry” and that has an engagement angle that is still able to carry torque and stop the rotation of the spinning member or plate 13. The “sloped geometry” of the reverse notch 15 allows for some tolerance absorption in relationship to the distance between the two locking members 18 and 26. It also creates a wedging effect to eliminate any backlash between the locking members 18 and 26. This design also staggers or alternates the reverse notches with respect to the forward notches in order to be able to absorb more tolerance and still find a reverse strut 18 to wedge in and lock.

In other words, each of the set of reverse locking formations 15 includes a load bearing surface having a sloped geometry and which is adapted to lock a reverse locking element 18 in place along its load bearing surface based on the mechanical tolerance between the locking elements 18 and 26 through a wedging effect to prevent relative rotation in a reverse direction about the axis 50, to absorb at least a portion of the tolerance and to substantially eliminate any backlash between the locking elements 18 and 26 in their locked positions.

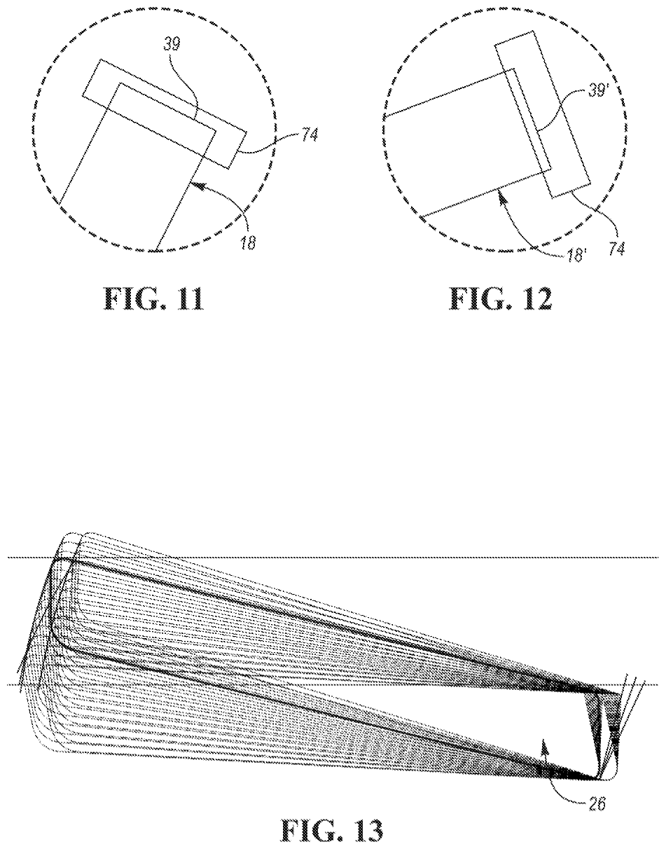

Referring now to FIGS. 10-12, FIG. 11 shows the tip or nose 39 of the reverse strut 18 with respect to a tolerance zone 74 in a first strut-and-notch possibility. FIG. 12 shows the tip or nose 39′ of a second reverse strut 18′ with respect to the tolerance zone 74 in a second strut-and-notch possibility. Other variations of this design would include a single set of reverse notches to absorb tolerance or multiple sets of reverse notch combinations to cover a wider range of tolerance. FIG. 13 shows different positions of the forward strut 26 by phantom lines.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A controllable coupling assembly having substantially no backlash, the assembly comprising:
a forward locking element including a nose end with a load bearing surface;
a reverse locking element including a nose end with a load bearing surface, a distance between the load bearing surfaces having a mechanical tolerance when the locking elements are both in their locked positions; and
first and second coupling members supported for relative rotation about a common rotational axis, the coupling members including:
a first coupling face having a forward pocket to receive the forward locking element; and
a second coupling face having a set of forward locking formations, each of the set of forward locking formations being adapted for abutting engagement with the load bearing surface of the forward locking element in its locked position to prevent the relative rotation in a forward direction about the axis and a set of reverse locking formations, each of the set of reverse locking formations including a load bearing surface having a sloped geometry and being adapted to lock the reverse locking element in place along the load bearing surface of its reverse locking formation based on the mechanical tolerance through a wedging effect to prevent relative rotation in a reverse direction about the axis, to absorb at least a portion of the tolerance and to substantially eliminate any backlash between the locking elements in their locked positions.

2. The assembly as claimed in claim 1, wherein the first coupling face has a reverse pocket to receive the reverse locking element.

3. The assembly as claimed in claim 1, including a plurality of reverse locking elements wherein the first coupling face has a plurality of reverse pockets to receive the reverse locking elements.

4. The assembly as claimed in claim 1, wherein the first coupling face is oriented to face axially in a first direction along the axis, and wherein the second coupling face is oriented to face axially in a second direction opposite the first direction along the axis.

5. The assembly as claimed in claim 1, wherein the forward and reverse locking elements are locking struts.

6. The assembly as claimed in claim 1, wherein the forward and reverse locking formations include notches.

7. The assembly as claimed in claim 1, wherein the reverse locking formations are staggered to absorb at least a portion of the tolerance.

8. The assembly as claimed in claim 3, further comprising:
a control member mounted for controlled, shifting movement between the first and second coupling faces relative to the reverse pockets and operable for controlling position of the reverse locking elements, the control member allowing at least one of the reverse locking elements to engage at least one of the reverse locking formations in a first position of the control member and wherein the control member maintains the reverse locking elements in their pockets in a second position of the control member.

9. The assembly as claimed in claim 8, wherein the control member comprises a slide plate controllably rotatable about the rotational axis between the first and second positions.

10. The assembly as claimed in claim 8, wherein the reverse locking element has a control member-engaging appendage at its nose end.

11. A controllable clutch assembly having substantially no backlash, the assembly comprising:
a forward locking element including a nose end with a load bearing surface;
a reverse locking element including a nose end with a load bearing surface, a distance between the load bearing surfaces having a mechanical tolerance when the locking elements are both in their locked positions; and
first and second clutch members supported for relative rotation about a common rotational axis, the clutch members including:
a first clutch face having a forward pocket to receive the forward locking element; and
a second clutch face having a set of forward locking formations, each of the set of forward locking formations being adapted for abutting engagement with the load bearing surface of the forward locking element in its locked position to prevent the relative rotation in a forward direction about the axis and a set of reverse locking formations, each of the set of reverse locking formations including a load bearing surface having a sloped geometry and being adapted to lock the reverse locking element in place along the load bearing surface of its reverse locking formation based on the mechanical tolerance through a wedging effect to prevent relative rotation in a reverse direction about the axis, to absorb at least a portion of the tolerance and to substantially eliminate any backlash between the locking elements in their locked positions.

12. The assembly as claimed in claim 11, wherein the first clutch face has a reverse pocket to receive the reverse locking element.

13. The assembly as claimed in claim 11, including a plurality of reverse locking elements wherein the first clutch face has a plurality of reverse pockets to receive the reverse locking elements.

14. The assembly as claimed in claim 11, wherein the first clutch face is oriented to face axially in a first direction along the axis, and wherein the second clutch face is oriented to face axially in a second direction opposite the first direction along the axis.

15. The assembly as claimed in claim 11, wherein the forward and reverse locking elements are locking struts.

16. The assembly as claimed in claim 11, wherein the forward and reverse locking formations include notches.

17. The assembly as claimed in claim 11, wherein the reverse locking formations are staggered to absorb at least a portion of the tolerance.

18. The assembly as claimed in claim 13, further comprising:
a control member mounted for controlled, shifting movement between the first and second clutch faces relative to the reverse pockets and operable for controlling position of the reverse locking elements, the control member allowing at least one of the reverse locking elements to engage at least one of the reverse locking formations in a first position of the control member and wherein the control member maintains the reverse locking elements in their pockets in a second position of the control member.

19. The assembly as claimed in claim 18, wherein the control member comprises a slide plate controllably rotatable about the rotational axis between the first and second positions.

20. The assembly as claimed in claim 18, wherein the reverse locking element has a control member-engaging appendage at its nose end.
